(19) United States
(12) Patent Application Publication
(10) Pub. No.: US 2014/0253447 A1
(43) Pub. Date: Sep. 11, 2014

(54) MOUSE AND INPUTTING METHOD THEREOF

(71) Applicant: DEXIN CORPORATION, NEW TAIPEI CITY (TW)

(72) Inventor: YUAN-JUNG CHANG, NEW TAIPEI CITY (TW)

(73) Assignee: DEXIN CORPORATION, NEW TAIPEI CITY (TW)

(21) Appl. No.: 13/787,252

(22) Filed: Mar. 6, 2013

(51) Int. Cl. G06F 3/038

(52) U.S. Cl. CPC G06F 3/0383
USPC 345/163

(57) ABSTRACT

A mouse includes an input unit, an output unit, and a control unit. The control unit is coupled to the input unit and the output unit. The control unit receives an input action sequence inputted by the input unit and determines whether the input action sequence matches with a predetermined action sequence. If so, a fast inputting signal corresponding to the predetermined action sequence is outputted to a computer apparatus via the output unit, wherein the fast inputting signal replaces an inputting operation performed by a keyboard apparatus to the computer apparatus, wherein an input action sequence is a combination of multiple groups of the inputting operation signals continuously inputted by the input unit in a fixed order.

### BACKGROUND OF THE INVENTION

1. Field of the Invention

The present invention relates to a mouse and inputting method thereof; in particular, to a mouse for generating a fast inputting signal and inputting method thereof.

2. Description of Related Art

With the progress of computer technology, people's life in this age is almost intimately associated with the computer apparatus, for example, people can easily use a computer apparatus for transferring money into an account, inquiring about labor insurance data, logging into a social web site or sending and receiving e-mail messages, etc. Thus, the personal data protection and security also tends to be important, for example, website login password must be updated at a regular interval to prevent hacking or damage.

However, people must update the login password at a regular interval according to the specific setting rules of the website, and must press the keyboard apparatus several times to input password such as texts, numbers, symbols, or combination of said texts, numbers and symbols and so on. The login password will be set with specific setting rules, for example, the login password can not be set with consecutive numbers, birthday or ID card number or the login password must have more than eight characters and so on. Therefore, people need to press the keyboard apparatus several times to input the login password with specific setting rules, thus it is not convenient to login the website.

### SUMMARY OF THE INVENTION

The present invention is for providing mouse and inputting method thereof, in order to solve the aforementioned problems.

The present invention discloses a mouse comprising an input unit, an output unit and a control unit. The control unit is coupled to the input unit and the output unit, and receives an input action sequence of the input unit and determines whether the input action sequence matches with a predetermined action sequence. If so, a fast inputting signal corresponding to the predetermined action sequence is outputted to a computer apparatus via the output unit, wherein the fast inputting signal is used to replace an inputting operation performed by a keyboard apparatus to the computer apparatus. The input action sequence is a combination of multiple groups of inputting operation signals continuously inputted by the input unit in a fixed order.

In an embodiment of the present invention, the mouse further includes a storage unit storing a conversion table, for recording the relationship of the fast inputting signal corresponding with at least one predetermined action sequence. The control unit determines based on the conversion table whether the input action sequence matches with the predetermined action sequence and whether the fast inputting signal is a password or a macro command.

In an embodiment of the present invention, the input unit belongs to at least one or a combination of a left mouse button, a right mouse button, a mouse roller and a mouse displacement sensor.

The present invention discloses a mouse comprising an input unit, an output unit and a control unit. The control unit is coupled to the input unit and the output unit, and receives an input action sequence of the input unit and determines whether the input action sequence matches with a predetermined action sequence or not. If so, one of multiple fast inputting signals corresponding to the predetermined action sequence is outputted to a computer apparatus via the output unit, wherein the fast inputting signal is used to replace an inputting operation performed by a keyboard apparatus to the computer apparatus. The input action sequence is a combination of multiple groups of inputting operation signals continuously inputted by the input unit in a fixed order.

In an embodiment of the present invention, the mode used by the control unit to select one of multiple fast inputting signals corresponding to the predetermined action sequence is to select a fast inputting signal corresponding to the browsed web page or the running application program of the computer apparatus.

The present invention discloses an inputting method for a mouse, and the method comprises: determining whether an input unit of the mouse inputs an input action sequence matching with a predetermined action sequence; and if so, a fast inputting signal corresponding to the predetermined action sequence is outputted to a computer apparatus via an output unit of the mouse, wherein the fast inputting signal is used to replace an inputting operation performed by a keyboard apparatus to the computer apparatus, and the input action sequence is a combination of multiple groups of inputting operation signals continuously inputted by the input unit in a fixed order.

In an embodiment of the present invention, the predetermined action sequence is arranged according to time sections or time sequence.

The present invention discloses an inputting method for a mouse, and the method comprises: determining whether an input unit of the mouse inputs an input action sequence matching with a predetermined action sequence; and if so, one of multiple fast inputting signals corresponding to the predetermined action sequence is outputted to a computer apparatus via an output unit of the mouse, wherein the fast inputting signal is used to replace an inputting operation performed by a keyboard apparatus to the computer apparatus, and the input action sequence is a combination of multiple groups of inputting operation signals continuously inputted by the input unit in a fixed order.

In the specific means of the present invention, the mouse is used to input accurate input action sequence, then the corresponding fast inputting signal is outputted to the computer apparatus via the output unit, wherein the fast inputting signal is used to replace an inputting operation performed by a keyboard apparatus to the computer apparatus. Thus, the convenience to login to the website and to execute macro commands of the application program may be enhanced by the mechanism described above, so as to effectively solve the problems such as forgetting the regularly updated password or entering a wrongly-remembered login password in a web site and so on.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a spatial operating diagram of a mouse according to an embodiment of the present invention;

FIG. 2 shows a functional block diagram of a mouse according to an embodiment of the present invention in FIG. 1;

FIG. 3 shows a conversion table of the mouse according to an embodiment of the present invention in FIG. 2;

FIG. 4 shows a flow chart of an inputting method for a mouse according to another embodiment of the present invention;

FIG. 5 shows a conversion table of a mouse according to another embodiment of the present invention in FIG. 2; and

FIG. 6 shows a flow chart of an inputting method for a mouse according to another embodiment of the present invention in FIG. 5.

### DETAILED DESCRIPTION OF THE PREFERRED EMBODIMENTS

### First Embodiment

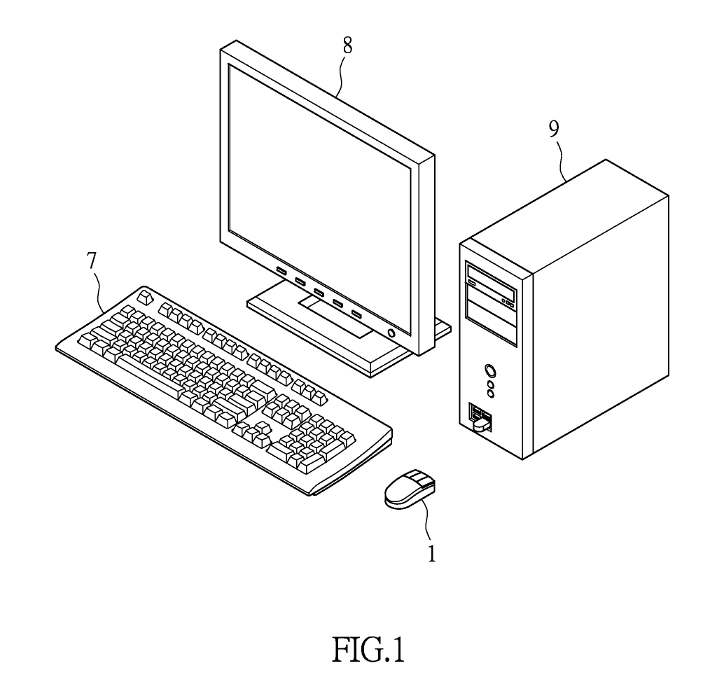

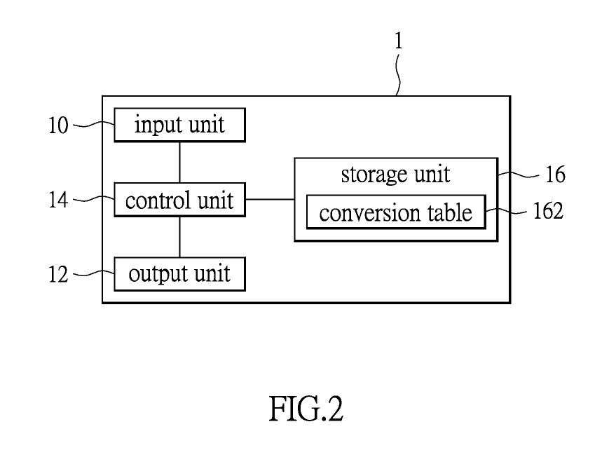

In a first exemplary embodiment of the invention, FIG. 1 shows a spatial operating diagram of a mouse. FIG. 2 shows a functional block diagram of the mouse according to FIG. 1. Please refer to FIG. 1 and FIG. 2. A mouse 1 comprises an input unit 10, an output unit 12, a control unit 14 and a storage unit 16. Practically speaking, the mouse 1, such as a wired mouse or a wireless mouse, is for cursor operation of a computer apparatus 9. For example, an inputting operation signal of the wired mouse can be transmitted through a cable between the wired mouse and the computer apparatus 9. Wireless signal may be transmitted between a wireless mouse and a computer host by means of Bluetooth communication protocol, wireless radio frequency (RF) communication protocol or IEEE 802.11 communication protocol. The type of the mouse 1 is not limited in the embodiments of the present disclosure.

Referring to FIG. 2, the input unit 10 belongs to at least one or a combination of a left mouse button, a right mouse button, a mouse roller and a mouse displacement sensor. Of course, when the input unit 10 is pressed, rolled or moved, a corresponding inputting operation signal is generated and transmitted to the control unit 14. The inputting operation signal is a right mouse button signal, a left mouse button signal, a mouse roller signal or a mouse displacement signal. One skilled in the art will also understand the functions of the input unit 10 and the functions will not be described repeatedly.

It is worth noting that the input action sequence is a combination of multiple groups of inputting operation signals continuously inputted by the input unit 10 in a fixed order. For example, the right mouse button, the left mouse button and the right mouse button are pressed in a sequential order, and then multiple inputting operation signals such as the right mouse button signal, the left mouse button signal and the right mouse button signal etc. are generated. The combination of the multiple inputting operation signals is the input action sequence. The type of the input action sequence is not limited in the embodiments of the present disclosure, and one skilled in the art may freely design the type as required.

The control unit 14 is coupled among the input unit 10, the output unit 12 and the storage unit 16. The control unit 14 may be a central processing unit (CPU) or micro processing unit (MCU) etc., for performing the signal calculation and processing among each unit in the mouse 1. In practice, the control unit 14 may determine to transmit the inputting operation signal or the fast inputting signal to the output unit 12.

For example, when an input action sequence inputted by the input unit 10 does not match with the predetermined action sequence, the inputting operation signal is transmitted to the output unit 12 for performing a general operation. When an input action sequence inputted by the input unit 10 matches with the predetermined action sequence, then the fast inputting signal is transmitted to the output unit 12. Therefore, the fast inputting signal will be transmitted to the computer apparatus 9 for performing a fast operation or a convenient operation.

In a detailed description, the control unit 14 is coupled between the input unit 10 and the output unit 12. The control unit 14 receives the input action sequence inputted by the input unit 10, and determines whether the input action sequence matches with the predetermined action sequence or not; if so, a fast inputting signal corresponding to the predetermined action sequence is outputted to a computer apparatus 9 via the output unit 12, wherein the fast inputting signal replaces an inputting operation performed by the keyboard apparatus 7 to the computer apparatus 9.

It is worth noting that the predetermined action sequence may be one of multiple groups of fast inputting signals and is outputted to a computer apparatus 9 via the output unit 12. The type that a predetermined action sequence corresponds to a fast inputting signal or a predetermined action sequence corresponds to multiple fast inputting signals is not limited in this embodiment.

For example, the user often must update regularly a login password of a first financial website, the user only uses a fixed group of input action sequences, and the input action sequences match with the predetermined action sequence for logging into the first financial website, then the predetermined action sequence will generate a login password of the first financial website. Therefore, the user uses the input action sequence to operate the mouse 1, and then may login the first financial website.

In addition, the predetermined action sequence and the fast inputting signal may be designed according to the requirement of the user. For example, in the mouse 1 the setting of the predetermined action sequence and the fast inputting signal may be realized by a configuration button (not illustrated), application program or firmware. Thus, the user may modify, change or edit the predetermined action sequence and the fast inputting signal.

For example, the user presses a configuration button (not illustrated) of the mouse 1 for setting the predetermined action sequence, and the control unit 14 of the mouse 1 will record the input action sequence as the predetermined action sequence. For example, the input action sequence may be [symbol] pressing right mouse button three times and pressing left mouse button twice [symbol] , then the user inputs the fast inputting signals of any key combination such as [symbol] abcde123 [symbol] entered through the keyboard apparatus 7. When the user presses the configuration button (not illustrated) one time again, the control unit 14 of the mouse 1 will record the input action sequence [symbol] pressing the right mouse button three times and pressing the left mouse button twice [symbol] as the predetermined action sequence, and the any key combination [symbol] abcde123 [symbol] is the fast inputting signal for logging in the website, and then will be stored to the storage unit 16.

In the same manner, the user may also set the fast inputting signal. For example, the fast inputting signal is a macro command, wherein the macro command has a copy function of the key combination of “Ctrl+Alt+C”. Therefore, the user uses the input action sequence to operate the mouse 1 for generating the macro command having a copy function. Thus, one skilled in the art will understand easily that in the mouse 1 the setting of the predetermined action sequence and the fast inputting signal is realized by the configuration button (not illustrated), application program or firmware.

The storage unit 16 may be composed of the non-volatile memory, such as a flash memory or an electronically erasable programmable read-only memory (EEPROM). In practice, the storage unit 16 stores a conversion table 162, which records the relationship for at least one fast inputting signal corresponding to the predetermined action sequence. The control unit 14 determines according to the conversion table 162 whether the input action sequence matches with the predetermined action sequence or not, and the fast inputting signal is a password or a macro command.

To explain in detail, a group of the predetermined action sequence of the conversion table 162 may correspond to a group of the fast inputting signal. Thus, the user inputs a group of fast action sequence that matches with the predetermined action sequence, and then a group of fast inputting signals is generated correspondingly to login a website, run an application program or execute a macro command. Alternatively, a single predetermined action sequence of the conversion table 162 may correspond to multiple fast inputting signals. Therefore, the user inputs a group of input action sequences that match with the predetermined action sequence, and then multiple groups of fast inputting signals are generated. Of course, multiple groups of fast inputting signals may choose a browsed webpage corresponding to a computer apparatus by means of firmware or execute one of multiple groups of the fast inputting signals of an application program, so as to login a website, run an application program or execute a macro command. On the basis of the above, the conversion table 162 may be designed according to the requirements of the user. The type of the conversion table 162 is not limited in the present embodiment.

It is worth noting that the mouse 1 further includes an output port (not illustrated), said output port is coupled to the storage unit 16 of the mouse 1, and the conversion table 162 of the storage unit 16 may be transmitted to the computer apparatus 9 via said output port. Thus, the user may get or edit the detailed data of the conversion table 162. In other embodiments, the mouse 1 has a timer unit (not illustrated). The timer unit (not illustrated) is coupled to the control unit 14, wherein the predetermined action sequence is arranged according to time sections or time sequence. The type of the mouse 1 is not limited in the present embodiment.

The output unit 12, for instance, may be a wireless transmitter or a RF transmitter, for receiving the inputting operation signal or the fast inputting signal transmitted by the control unit 14, and then transmitting the inputting operation signal and the fast inputting signal to the computer apparatus 9, so that the computer apparatus 9 executes a command corresponding to the inputting operation signal or the fast inputting signal, wherein the fast inputting signal makes the computer apparatus 9 run the application program, login a browsed website or execute a macro command. In other embodiments, the output unit 12 may be also a wired transmitter. The type of the output unit 12 is not limited in this embodiment.

Based on the above, the user must regularly update the login password for a website or execute the macro command for an application program. The user may operate only the mouse 1, and use a group of input action sequences which match with the predetermined action sequences, and the fast inputting signal corresponding to the predetermined action sequence is outputted to the computer apparatus 9 via the output unit 12, wherein the fast inputting signal replaces an inputting operation performed by the keyboard apparatus 7 to the computer apparatus 9. Thus, the user uses a fixed input action sequence, to achieve a function of regularly updating a website password and fast logging in a website, or fast executing a macro command of an application program. Thus, the mouse 1 may improve the convenience to login a web site or execute a macro command of an application program.

### Second Embodiment

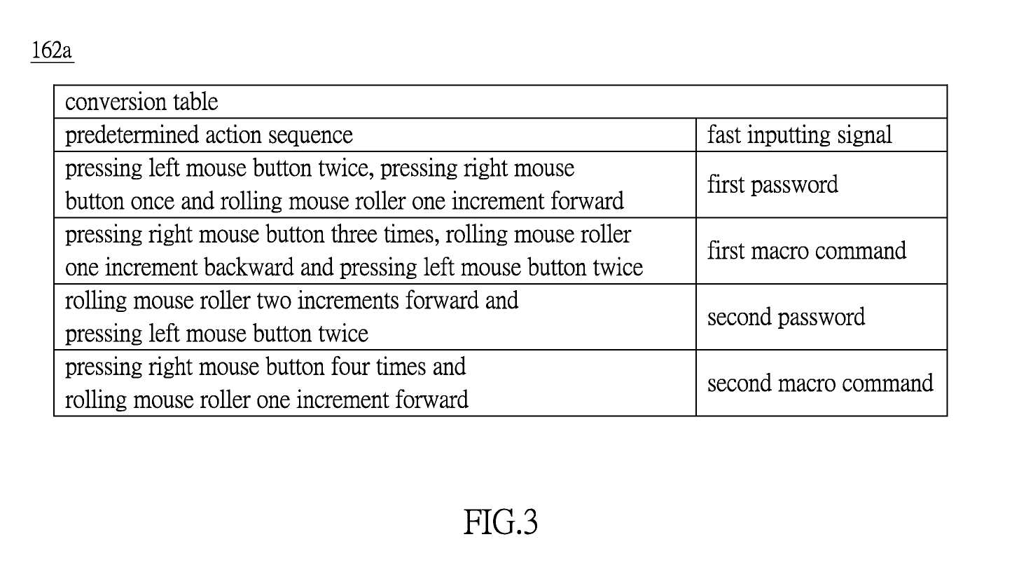

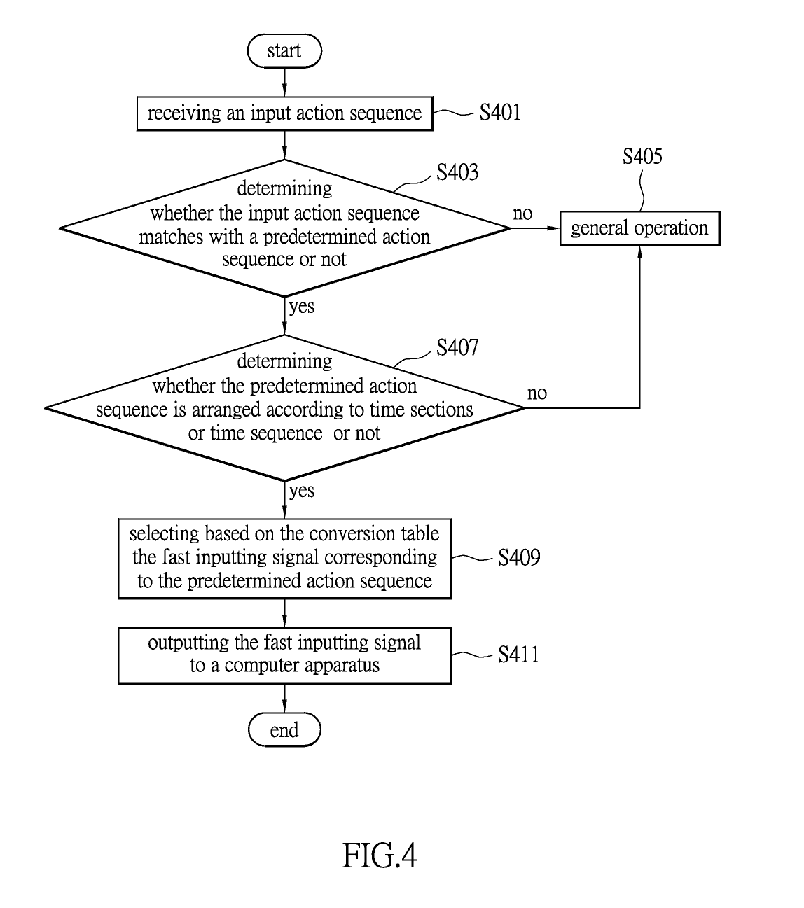

Next, an operation flowchart of the inputting method for the mouse is explained in detail. In a second exemplary embodiment of the invention, FIG. 3 shows a conversion table of the mouse according to an embodiment in FIG. 2. FIG. 4 shows a flow chart of an inputting method according to another embodiment of the present invention. Please refer to FIG. 4 and FIG. 3. An inputting method for a mouse comprises the following steps: in step S401, the user operates the mouse to receive an input action sequence. Next, in step S403, it is determined whether an input unit of a mouse inputs an input action sequence which matches with a predetermined action sequence. If so, the step S407 is performed to determine whether the predetermined action sequence is arranged according to time sections or time sequence. If not, the step S405 of a general operation of the mouse is performed, and one skilled in the art will understand the function of the general operation of the mouse, therefore the details of the function are not repeated here.

In a detailed description of the step S403, it is determined whether the input unit of the mouse inputs the input action sequence which matches with a corresponding predetermined action sequence, and a conversion table 162a is used to determine the validity of the input action sequence, wherein the conversion table 162a records the relationship for at least one fast inputting signal corresponding to the predetermined action sequence, and the fast inputting signal is a password or a macro command.

For example, please refer to FIG. 3. FIG. 3 illustrates the conversion table 162a which is the detailed data of the conversion table 162 stored in the storage unit of FIG. 2. FIG. 3 illustrates the predetermined action sequence that is a combination of “pressing the left mouse button twice and pressing the right mouse button once and then rolling the mouse roller one increment forward”, then a first password is generated. The first password, for instance, may be a login password of a first financial website. When the user operates the mouse and then the mouse receives an input action sequence that matches with a predetermined action sequence for generate a first password, then the user may operate the mouse to login the first financial website. Thus, when the website regularly updates a password, the mouse may receive identical input action sequence to generate the first password, and the first password is set based on that the user operates the keyboard apparatus.

Please refer to FIG. 3 and FIG. 4. In the step S407, it is determined whether the predetermined action sequence is arranged according to the time sections or time sequence. For example, the predetermined action sequence corresponding to the first password may be “pressing the left mouse button twice and pressing the right mouse button once and then rolling the mouse roller one increment forward” according to time sequence. When the input action sequence of the mouse is arranged to be “rolling the mouse roller one increment forward and pressing the right mouse button once and then pressing the left mouse button twice”, and said input action sequence does not match with the predetermined action sequence corresponding to the first password, then a general operation of the mouse is performed.

However, in other embodiments, when the input action sequence of the mouse matches with a trigger action, said timer unit start to count time. For example, a trigger action of the predetermined action sequence of the first password may be “pressing the left mouse button twice”. When an inputting action of the mouse matches with said trigger action, said timer unit start to count time with a time section, for instance the time section may be 10 second. When the user has not completed “pressing the right mouse button once and then rolling the mouse roller one increment forward” of the predetermined action sequence of the first password after a trigger action within 10 second, the step S405 is performed.

When the user has completed “pressing the right mouse button once and then rolling the mouse roller one increment forward” of the predetermined action sequence of the first password after a trigger action within 10 second, the step S409 is performed. In addition, during the counting of the timer unit, if the input action sequence of the mouse has not been completed or after the input action sequence of the mouse has been completed, the timer unit will reset to zero and then wait for a trigger action to recount. The operation of the timer unit and the time sections of the predetermined action sequence are not limited in the present embodiment, and may be designed freely by the one skilled in the art according to the actual needs.

Next, please refer to FIG. 4 and FIG. 3. In the step S409, the fast inputting signal corresponding to the predetermined action sequence is selected based on a conversion table 162a. For example, when the predetermined action sequence is “pressing the right mouse button three times and rolling the mouse roller one increment backward and then pressing the left mouse button twice”, the corresponding fast inputting signal is selected based on the conversion table 162a. Thus, the first macro command is generated. As an another example, when the predetermined action sequence is “rolling the mouse roller two increment forward and then pressing the left mouse button twice”, the fast inputting signal will be selected based on the conversion table 162a. Thus, a second password is generated.

In the following step S411, the fast inputting signal is outputted to the computer apparatus. One skilled in the art will understand the function of outputting the fast inputting signal to the computer apparatus, and therefore details of the function are not repeated here.

### Third Embodiment

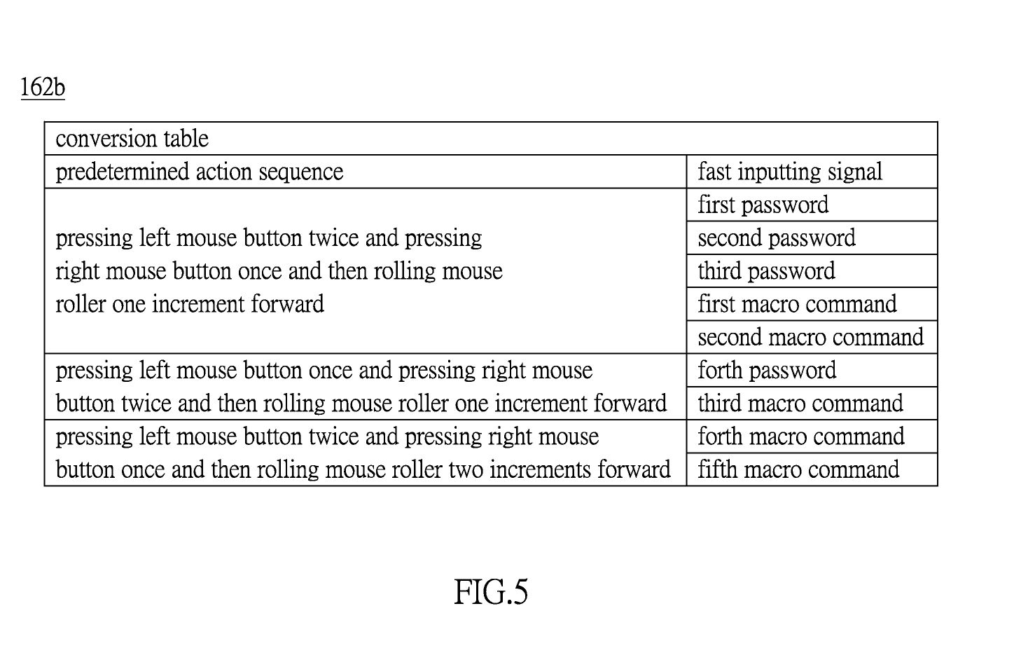

To make the one skilled in the art able to be more understandable, a conversion table for another embodiment of conversion table of the mouse is provided. FIG. 5 shows a conversion table of another embodiment of the present invention according to FIG. 2. Please refer to FIG. 5. The difference between the conversion table 162b in FIG. 5 and the conversion table 162a in FIG. 3 is that a group of predetermined action sequence listed on conversion table 162b corresponds to multiple groups of the fast inputting signals. Thus, the user uses a group of the input action sequence that matches with a predetermined action sequence to generate multiple groups of fast inputting signals.

To explain in detail, the control unit is coupled to the input unit and the output unit, for receiving an input action sequence inputted by the input unit, and determining whether the input action sequence matches with a predetermined action sequence. If so, one of multiple fast inputting signals corresponding to the predetermined action sequence is selected and outputted to a computer apparatus via the output unit. In one mode, the control unit may select one of multiple fast inputting signals corresponding to the predetermined action sequence, and the mode is performed by selecting a browsed webpage or executing the fast inputting signal of the application program.

For example, FIG. 5 illustrates the conversion table 162b which is detailed data of the conversion table 162 stored in the storage unit of FIG. 2. FIG. 5 illustrates the predetermined action sequence that is a combination of “pressing the left mouse button twice and pressing the right mouse button once and then rolling the mouse roller one increment forward”, then a fast inputting signal comprising first password, second password, third password, first macro command and second macro command will be generated.

The first password, second password and third password, for instance may be respectively the login password of the first, second and third Financial website, and first macro command and the second macro command for instance may be respectively the macro command executing A-application program and B-application program. When the user browses the entry homepage of a third financial website, the user operates the mouse, thus when the input action sequence received by the mouse matches with the predetermined action sequence, the mouse selects that one of multiple fast inputting signals corresponds to the predetermined action sequence. For instance, the login password of the third financial website is a third password, and the third password is outputted to a computer apparatus via the output unit. In one mode, the control unit may select one of multiple fast inputting signals corresponding to the predetermined action sequence, and the mode is performed by selecting the browsed webpage corresponding to the computer apparatus or executing the fast inputting signal of an application program.

In the same manner, the user may operate the mouse to login the first financial website, the second financial website or the third financial website. Thus, when the first financial website, the second financial website or the third financial website regularly updates the password, the mouse may receive identical input action sequence and browses the webpage corresponding to the computer apparatus, so that the first password of first Financial website, the second password of second Financial website or the third password of third Financial website may be generated. The first password, the second password or the third password may be set according to the keyboard apparatus operated by the user.

In addition, when the user operates the mouse to execute the macro command of an A-application program or a B-application program and thus the A-application program or the B-application program is executed, the mouse may receive identical input action sequence and then a first macro command of executed A-application or a second macro command of executed B-application is generated according to the application program executed by the computer apparatus. The first macro command or the second macro command may be set according to the keyboard apparatus operated by the user.

In addition to the above differences, one skilled in the art will understand that operation portion of the third exemplary embodiment is actually equivalent to that of the second exemplary embodiment. After one skilled in the art refers to the second exemplary embodiment and the above differences, the third exemplary embodiment may easily be inferred and will not be described repeatedly here.

### Fourth Embodiment

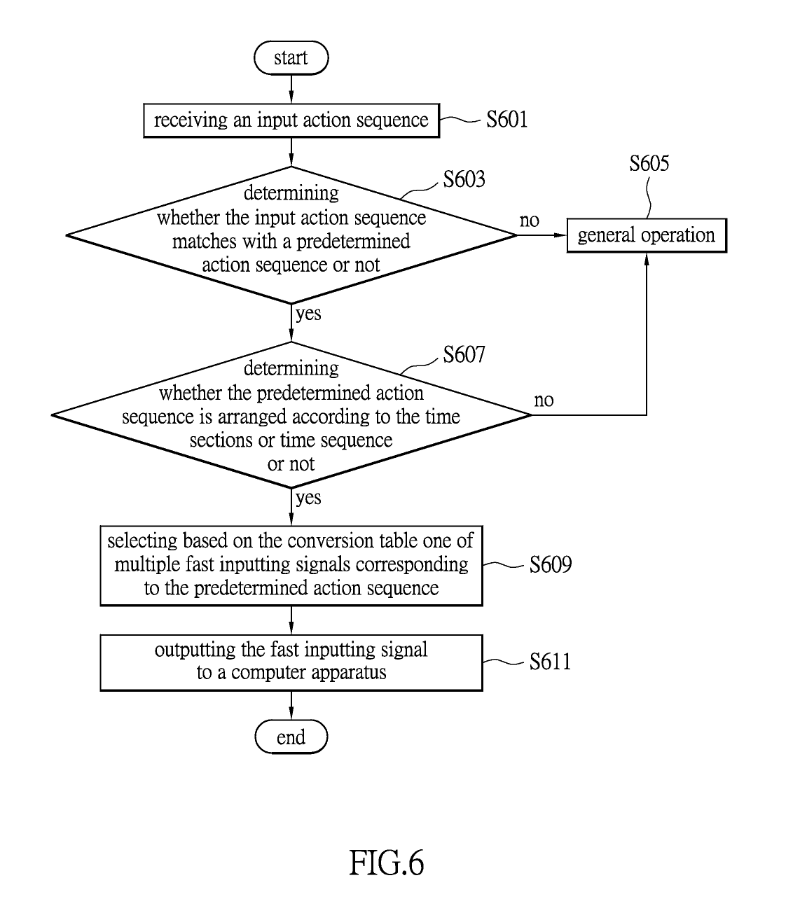

In a fourth exemplary embodiment of the invention, FIG. 6 shows a flow chart of another embodiment of the inputting method according to FIG. 5. Please refer to FIG. 6 and FIG. 5. The inputting method for a mouse in this embodiment is similar to the inputting method for a mouse in above-mentioned exemplary embodiment. For example, in the inputting method for the mouse it may be determined whether the input action sequence matches with the predetermined action sequence. However, the difference of the inputting methods for the mouse between this embodiment and the above-mentioned exemplary embodiment consists in the following steps. In the step S603, it is determined whether an input unit of a mouse inputs an input action sequence matching with a predetermined action sequence or not. If so, in the step S609, one of multiple fast inputting signals corresponding to the predetermined action sequence is selected and then outputted to a computer apparatus, wherein the fast inputting signal replaces an inputting operation performed by a keyboard apparatus to a computer apparatus. The input action sequence is a combination of multiple groups of the inputting operation signals continuously inputted by the input unit in a fixed order.

Whether the input action sequence of the input unit of the mouse matches with the predetermined action sequence is determined by means of a conversion table 162b, wherein the conversion table 162b records the relationships of the multiple fast inputting signals corresponding to at least one predetermined action sequence, and the fast inputting signal may be a password or a macro command.

In one mode, one of the multiple fast inputting signals corresponding to the predetermined action sequence is selected, and the mode is performed by selecting the browsed webpage corresponding to the computer apparatus or executing the fast inputting signal of the application program. To explain in detail, for instance the mouse may have a firmware for detecting a web page or an application program. When the pointer of the mouse operates on a browsed webpage, said firmware will provide a signal of said browsed webpage to the control unit. Thus, the control unit may select a fast inputting signal corresponding to the browsed webpage. In the same manner, when the pointer of the mouse operates on an application program, said firmware will provide a signal of said application program to the control unit. Thus, the control unit selects a fast inputting signal corresponding to said application program.

In addition to the above differences, one skilled in the art will understand that operation portion of the fourth embodiment is actually equivalent to that of the second embodiment. After one skilled in the art refers to the second exemplary embodiment and the above differences, the fourth embodiment may be easily inferred and is not described repeatedly here.

In summary, the spirit of the present invention consists primarily in that the mouse is used for inputting a correct input action sequence, and then the input action sequence matches with the predetermined action sequence listed on the conversion table of the mouse. The fast inputting signal is generated according to the predetermined action sequence and outputted to the computer apparatus via the output unit, wherein the fast inputting signal replaces an inputting operation performed by a keyboard apparatus to the computer apparatus. As a result, in the present invention the convenience for logging in a website and executing the macro command of an application program is enhanced, and the problem such as forgetting the regularly updated password or entering a wrongly-remembered login password in a website and so on is effectively solved.

What is claimed is:

1. A mouse, comprising:
an input unit;
an output unit; and
a control unit, coupled to the input unit and the output unit, for receiving an input action sequence of the input unit and determining whether the input action sequence matches with a predetermined action sequence; if so, a fast inputting signal corresponding to the predetermined action sequence being outputted to a computer apparatus;
wherein the fast inputting signal replaces an inputting operation performed by a keyboard apparatus to the computer apparatus;
wherein the input action sequence is a combination of multiple groups of the inputting operation signals continuously inputted by the input unit in a fixed order.

2. The mouse according to claim 1, further comprising a storage unit, storing a conversion table which records the relationship of the fast inputting signal corresponding to at least one predetermined action sequence; wherein the control unit determines based on the conversion table whether the input action sequence matches with the predetermined action sequence, and wherein the fast inputting signal is a password or a macro command.

3. The mouse according to claim 1, wherein the input unit belongs to at least one or a combination of a left mouse button, a right mouse button, a mouse roller and a mouse displacement sensor.

4. The mouse according to claim 1, wherein, when the input action sequence matches with the predetermined action sequence, one of multiple fast inputting signals corresponding to the predetermined action sequence is selected by the control unit and outputted to the computer apparatus, wherein the selected fast inputting signal corresponds to a browsed webpage of the computer apparatus or executes an application program.

5. An inputting method for a mouse, comprising:
determining whether an input unit of the mouse inputs an input action sequence that matches with a predetermined action sequence; and
if so, a fast inputting signal corresponding to the predetermined action sequence being outputted to a computer apparatus via an output unit of the mouse, wherein the fast inputting signal replaces an inputting operation performed by a keyboard apparatus to the computer apparatus;
wherein the input action sequence is a combination of multiple groups of the inputting operation signals continuously inputted by the input unit in a fixed order.

6. The inputting method for the mouse according to claim 5, wherein the step of determining whether the input unit of the mouse inputs an input action sequence matching with a predetermined action sequence is performed by using a conversion table, wherein the conversion table records the relationship of the fast inputting signal corresponding to at least one predetermined action sequence, and wherein the fast inputting signal is a password or a macro command.

7. The inputting method for the mouse according to claim 5, wherein the inputting operation signal is a right mouse button signal, a left mouse button signal, a mouse roller signal or a mouse displacement signal.

8. The inputting method for the mouse according to claim 5, wherein the predetermined action sequence is arranged according to time sections or time sequence.

9. An inputting method for a mouse, comprising:
determining whether an input unit of the mouse inputs an input action sequence matching with a predetermined action sequence; and
if so, one of multiple fast inputting signals corresponding to the predetermined action sequence being selected and outputted to a computer apparatus via an output unit of the mouse, wherein the fast inputting signal replaces an inputting operation performed by a keyboard apparatus to the computer apparatus;
wherein the input action sequence is a combination of multiple groups of the inputting operation signals continuously inputted by the input unit in a fixed order.

10. The inputting method for the mouse according to claim 9, wherein the step of determining whether the input unit of the mouse inputs the input action sequence matching with the predetermined action sequence is performed by using a conversion table, wherein the conversion table records the relationships of the multiple fast inputting signals corresponding to at least one predetermined action sequence, and wherein the fast inputting signals are passwords or macro commands.

11. The inputting method for the mouse according to claim 9, wherein a mode for selecting one of the multiple fast inputting signals corresponding to the predetermined action sequence is to select a fast inputting signal corresponding to a browsed webpage of the computer apparatus or executing an application program.

12. The inputting method for the mouse according to claim 9, wherein the inputting operation signal is a right mouse button signal, a left mouse button signal, a mouse roller signal or a mouse displacement signal.

13. The inputting method for the mouse according to claim 9, wherein the predetermined action sequence is arranged according to time sections or time sequence.
